(19) United States
(12) Patent Application Publication
(10) Pub. No.: US 2006/0145986 A1
(43) Pub. Date: Jul. 6, 2006

(54) Liquid crystal display, and method and system for automatically adjusting flicker of the same

(75) Inventors: Jae-Ho OH, Seoul (KR); Jae-Hyoung Park, Yongin-si (KR); Tae-Sung Kim, Suwon-si (KR); Seung-Woo Lee, Seoul (KR)

Correspondence Address: MCGUIREWOODS, LLP, 1750 TYSONS BLVD, SUITE 1800, MCLEAN, VA, 22102, US

(73) Assignee: Samsung Electronics Co., Ltd.

(21) Appl. No.: 11/299,733

(22) Filed: Dec. 13, 2005

(30) Foreign Application Priority Data
Jan. 4, 2005 (KR) 10-2005-0000409

(51) Int. Cl. G09G 3/36

(52) U.S. Cl. 345/92

(57) ABSTRACT

A method of automatically adjusting a flicker of a liquid crystal display including a digital variable resistor (DVR) generating a common voltage on the basis of an input signal, and the method includes: locating a photographing device in front of the liquid crystal display; verifying a default value stored in the DVR; performing a rough flicker measurement; generating a quadratic equation; determining a solution of the quadratic equation; performing a fine flicker measurement; selecting an optimum value; and inputting the optimum value to the DVR.

### CROSS REFERENCE TO RELATED APPLICATION

This application claims priority to and the benefit of Korean Patent Application No. 10-2005-0000409, filed on Jan. 4, 2005, which is hereby incorporated by reference for all purposes as if fully set forth herein.

### BACKGROUND OF THE INVENTION

1. Field of the Invention

The present invention relates to a liquid crystal display, and a method and a system of automatically adjusting a flickering phenomenon of the liquid crystal display.

2. Description of Related Art

A liquid crystal display (LCD) includes a liquid crystal (LC) panel assembly having two panels that are provided with pixel electrodes and common electrodes, and an LC layer with dielectric anisotropy interposed therebetween. The pixel electrodes are arranged in a matrix and are connected with switching elements, such as thin film transistors (TFT), to be sequentially applied with a data voltage along a row. The common electrodes cover an entire surface of the upper panel and are supplied with a common voltage Vcom. A pixel electrode, a common electrode, and the LC layer form a LC capacitor in a circuit view. The LC capacitor and a switching element connected thereto form a basic unit of a pixel. To prevent the LC layer from deteriorating due to a one-directional electric field, the polarity of the data voltage is reversed for each frame, for each row, or for each dot with respect to the common voltage. Alternatively, the polarities of the data voltage and the common voltage may be reversed.

The difference between the data voltage and the common voltage Vcom applied to a pixel is expressed as a charged voltage of the LC capacitor, i.e., a pixel voltage.

However, such inversion driving causes the pixel voltage to be asymmetric, thereby generating a phenomenon in which a screen looks like it is flickering (hereinafter, referred to as ‘flicker’).

Many methods for preventing the flicker have been developed. For example, one method is to use a variable resistor. Another method to use a flicker adjuster.

When the variable resistor is used, an operator rotates the variable resistor positioned at the rear of the LCD himself/herself to change the common voltage, which adjusts the flicker. However, this must be performed manually, which takes time and results in variability due to each operator performing the operation differently.

When the flicker adjuster is used, digital values input to a digital variable resistor (DVR) are adjusted to change the common voltage, which adjusts the flicker. The method is easier to perform than the variable resistor method; however, it is difficult for the operator to Is input the digital values while seeing a screen of the LCD, and again there is variation for each operator. Further, a finally set value is stored in a memory such as an EEPROM, embodied in the LCD, and equipment provided with an I²C interface needed to read the value in the memory is not currently available; therefore the value cannot be read. Accordingly, the change history of the common voltage may only be determined by separate measuring equipment.

### SUMMARY OF THE INVENTION

The present invention provides a liquid crystal display and an adjusting method, and a system of the same that is capable of automatically adjusting a flicker. Additional features of the invention will be set forth in the description which follows, and in part will be apparent from the description, or may be learned by practice of the invention.

The present invention discloses a method for automatically adjusting a flicker of a liquid crystal display including a digital variable resistor (DVR) that generates a common voltage according to an input signal, the method including: providing a photographing device to measure luminance of the liquid crystal display; verifying a default value stored in the DVR; performing a first flicker measurement; generating a quadratic equation using data obtained from the first flicker measurement and solving the generated quadratic equation; performing a second flicker measurement; selecting an optimum value from data obtained from the second flicker measurement; and inputting the optimum value to the DVR.

The present invention also discloses an apparatus to automatically adjust a flicker, including a liquid crystal display (LCD); a photographing device photographing the LCD; and an electronic device coupled with the liquid crystal display and the photographing device, wherein the liquid crystal device includes a DVR that generates common voltages having different values according to an input signal received from the electronic device, and the electronic device determines a value for minimizing a flicker of the liquid crystal display to input to the DVR.

The present invention also discloses a liquid crystal display including a DVR that generates a first common voltage according to an input signal received from an external device, wherein the DVR is coupled with the external device and I²C interface.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of an LCD according to an embodiment of the invention.

FIG. 2 shows a structure and an equivalent circuit diagram of a pixel of an LCD according to an embodiment of the invention.

FIG. 3 shows a flicker adjusting system of an LCD according to an embodiment of the invention.

FIG. 4 is a block diagram showing a flicker adjusting system of an LCD according to an embodiment of the invention.

FIG. 5A is a graph showing a flicker amount depending on DVR values in an is LCD according to an embodiment of the invention.

FIG. 5B shows a principle for measuring a flicker amount.

FIG. 6 is a flow chart showing a flicker adjusting method of an LCD according to an embodiment of the invention.

FIGS. 7A, 7B, 7C, 7D, and 7E show a reference for selecting an optimum value in a flicker adjusting method of an LCD according to an embodiment of the invention.

FIG. 8 is a flow chart showing a flicker adjusting method of an LCD according to another embodiment of the invention.

FIG. 9A and FIG. 9B show a reference for selecting an optimum value in a flicker adjusting method of an LCD according to another embodiment of the invention.

### DESCRIPTION OF THE ILLUSTRATED EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

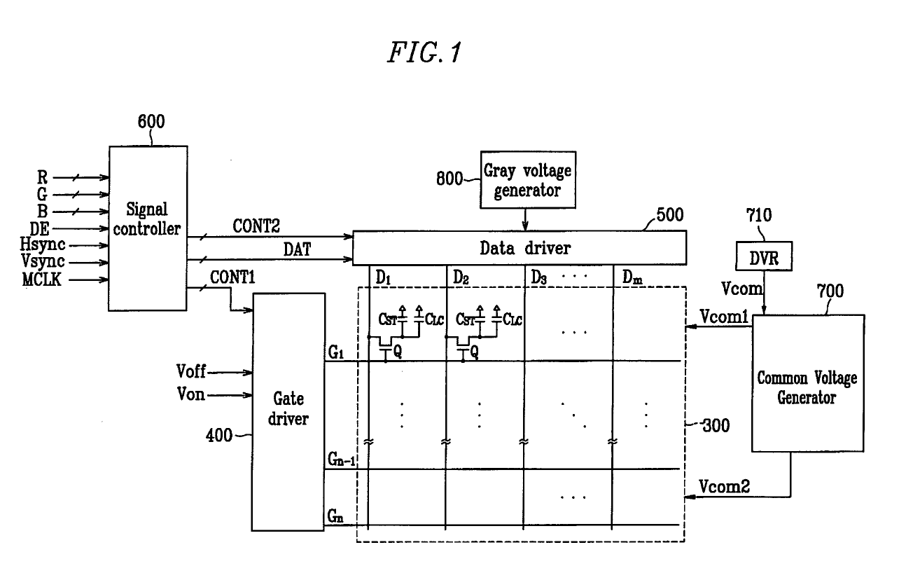

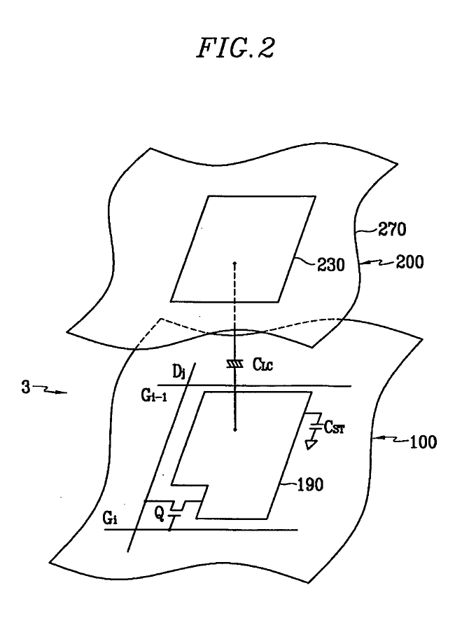

FIG. 1 is a block diagram of an LCD according to an exemplary embodiment of the present invention. FIG. 2 illustrates a structure and an equivalent circuit diagram of a pixel of an LCD according to an embodiment of the invention.

Referring to FIG. 1, an LCD includes an LC panel assembly 300, a gate driver 400 connected with the LC Panel assembly 300, a data driver 500 connected with the LC Panel assembly 300, a gray voltage generator 800 connected with the data driver 500, a common voltage generator 700 and a DVR 710 each connected with the data driver 500, and a signal controller 600 controlling the above-described elements.

The LC panel assembly 300, in a structural view shown in FIG. 2, includes a lower panel 100, an upper panel 200, and a liquid crystal (“LC”) layer 3 interposed therebetween. The LC panel assembly 300 also includes a plurality of display signal lines G1-Gn and D1-Dm and a plurality of pixels that are connected thereto and arranged substantially in a matrix, as shown in FIG. 1 and FIG. 2.

The display signal lines G₁-Gₙ and D₁-Dₘ may be provided on the lower panel 100 and include a plurality of gate lines G₁-G₁transmitting gate signals (referred to as “scanning signals”) and a plurality of data lines D₁-Dₘ transmitting data signals. The gate lines G₁-Gₙ may extend substantially in a row direction and the gate lines G₁-Gₙ are substantially parallel with each other. The data lines D₁-Dₘ may extend substantially in a column direction, e.g., opposite direction than the gate lines G₁-Gₙ, and they are substantially parallel with each other.

Each pixel may include a switching element Q that is connected, e.g., coupled, with the display signal lines G₁-Gₙ and D₁-Dₘ, and an LC capacitor C_{LC} and a storage capacitor C_{ST} that are connected, e.g., coupled, with the switching element Q. The storage capacitor C_{ST} may be omitted.

The switching element Q, such as a TFT, may be provided on the lower panel 100 and the switching element Q may include three terminals: a control terminal connected, e.g., coupled, with one of the gate lines G1-Gn; an input terminal connected, e.g., coupled, with one of the data lines D₁-Dₘ; and an output terminal connected, e.g., coupled, with the LC capacitor C_{LC} and the storage capacitor C_{ST}.

The LC capacitor C_{LC} includes a pixel electrode 190 that may be provided on the lower panel 100, a common electrode 270 that may be provided on the upper panel 200, and the LC layer 3 as a dielectric layer between the pixel electrode 190 and the common electrode 270. The pixel electrode 190 may be connected, e.g., coupled, with the switching element Q. The common electrode 270 covers the entire surface of the upper panel 100 and may be supplied with a common voltage Vcom. Alternatively, both the pixel electrode 190 and the common electrode 270, which may have a bar-like shape or a stripe-like shape, may be provided on the lower panel 100.

The storage capacitor C_{ST} may be an auxiliary capacitor for the LC capacitor C_{LC}. The storage capacitor C_{ST} may include the pixel electrode 190 and a separate signal line (not shown), which may be provided on the lower panel 100. The storage capacitor C_{ST} may overlap the pixel electrode 190 via an insulator, and is supplied with a predetermined voltage, such as the common voltage Vcom. Alternatively, the storage capacitor C_{ST} may include the pixel electrode 190 and an adjacent gate line (referred to as a previous gate line), which overlaps the pixel electrode 190 via an insulator.

For a color display, each pixel may uniquely represent a color; e.g., one of three primary colors such as red, green, and blue colors (spatial division) to obtain a desired color. Alternatively, the pixels may sequentially represent the three primary colors in time (temporal division) to obtain a desired color.

FIG. 2 shows an example of the spatial division in which each pixel includes a color filter 230 representing one of the three primary colors at a portion of the upper panel 200 facing the pixel electrode 190. Alternatively, the color filter 230 may be provided on or below the pixel electrode 190 on the lower panel 100.

A pair of polarizers (not shown) for polarizing light are attached on outer surfaces of the lower and upper panels 100 and 200 of the panel assembly 300.

Referring to FIG. 1, a gray voltage generator 800 generates one or two sets of gray voltages related to transmittance of the pixels. When two sets of the gray voltages are generated, the gray voltages in one set have a positive polarity with respect to the common voltage Vcom, and the gray voltages in the other set have a negative polarity with respect to the common voltage Vcom.

The DVR 710 includes an integrated circuit (IC) chip, and generates the common voltage Vcom according to values stored in an internal memory (not shown) for output to the common voltage generator 700.

The common voltage generator 700 generates a plurality of common voltages Vcom1 and Vcom2 according to the common voltage Vcom from the DVR to apply to the LC panel assembly 300.

The gate driver 400 is coupled with the gate lines G₁-Gₙ of the panel assembly 300, and synthesizes the gate-on voltage Von and the gate-off voltage Voff to generate gate signals to apply to the gate lines G₁-Gₙ. The gate on voltage Von and the gate-off voltage Voff may be synthesized from an external device.

The data driver 500 is connected, e.g., coupled, with the data lines D₁-Dₘ of the panel assembly 300 and applies data voltages, which are selected from the gray voltages supplied from the gray voltage generator 800, to the data lines D₁-Dₘ.

The drivers 400 and 500 may include at least one IC chip mounted or attached on either the panel assembly 300 or a flexible printed circuit (FPC) film such as a tape carrier package (TCP), which are attached with the LC panel assembly 300. Alternately, the drivers 400 and 500 may be integrated into the panel assembly 300 along with the display signal lines G₁-Gₙ and D₁-Dₘ and the TFT switching elements Q.

The signal controller 600 controls the gate driver 400 and the data driver 500.

The operation of the display device is described below with reference to FIG. 1.

The signal controller 600 is supplied with image signals R, G, and B and input control signals controlling the display of the image signals R, G, and B. The input control signals include, for example, a vertical synchronization signal Vsync, a horizontal synchronization signal Hsync, a main clock MCLK, and a data enable signal DE, from a graphic controller (not shown), e.g., an external graphic controller. After generating gate control signals CONT1 and data control signals CONT2 and processing the image signals R, G, and B that are suitable for the operation of the panel assembly 300 in response to the input control signals, the signal controller 600 provides the gate control signals CONT1 to the gate driver 400, and the processed image signals DAT and the data control signals CONT2 to the data driver 500.

The gate control signals CONT1 include a vertical synchronization start signal STV for informing the gate driver of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply the appropriate data voltages to the data lines D₁-Dₘ, and a data clock signal HCLK. The data control signals CONT2 may further include an inversion control signal RVS for reversing the polarity of the data voltages with respect to the common voltage Vcom.

The data driver 500 receives the processed image signals DAT for a pixel row from the signal controller 600, and converts the processed image signals DAT into the analogue data voltages selected from the gray voltages supplied from the gray voltage generator 800 in response to the data control signals CONT2 received from the signal controller 600.

Upon receiving the gate control signals CONT1 from the signal controller 600, the gate driver 400 applies the gate-on voltage Von to the gate lines G₁-Gₙ, thereby turning on the switching elements Q that are coupled with the gate lines G₁-Gₙ.

The data driver 500 applies the data voltages to corresponding data lines D₁-Dₘ for a turn-on time of the switching elements Q. This is referred to as a “one horizontal period” or a “1H” and is equivalent to one period of the horizontal synchronization signal Hsync, the data enable signal DE, and the gate clock signal CPV. The data voltages are then supplied to corresponding pixels via the turned-on switching elements Q.

The difference between the data voltage and the common voltage Vcom applied to a pixel is expressed as a charged voltage of the LC capacitor C_{LC}, i.e., a pixel voltage. The orientation of the liquid crystal molecules depend on a magnitude of the pixel voltage. The orientations determine a polarization of light passing through the LC capacitor C_{LC}. The polarizers convert light polarization into light transmittance.

By repeating the above-described operations, all gate lines G₁-Gₙ may be sequentially supplied with the gate-on voltage Von during a frame, thereby applying the data voltages to all pixels. When a next frame starts after finishing one frame, the inversion control signal RVS applied to the data driver 500 is controlled such that a polarity of the data voltages is reversed (referred to as “frame inversion”). The inversion control signal RVS may be controlled such that the polarity of the data voltages flowing in a data line in one frame is reversed. This is referred to as “row inversion” or “dot inversion.” Alternatively, the polarity of the data voltages in one packet may be reversed. This is referred to as “column inversion” or “dot inversion”.

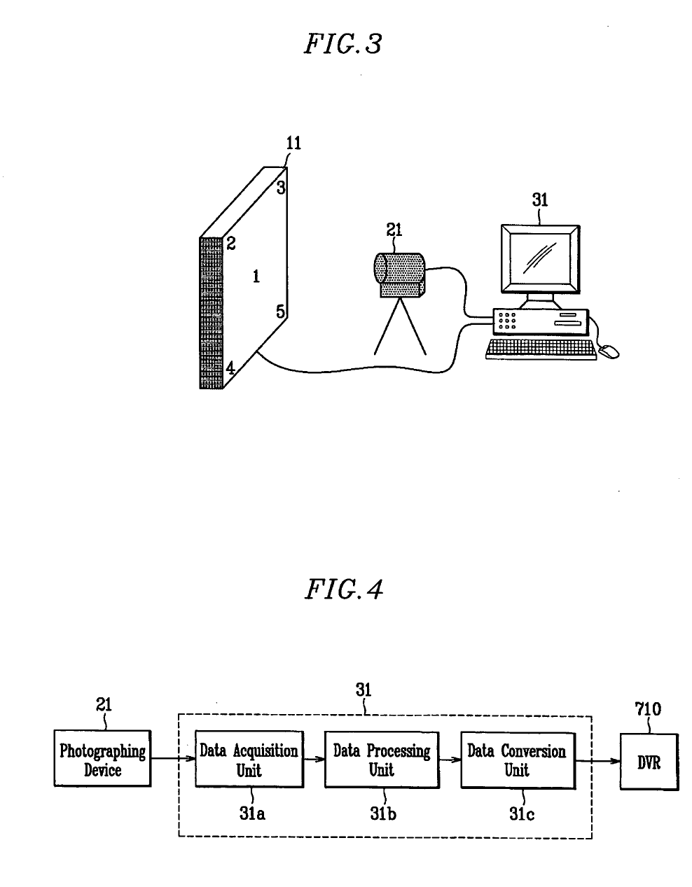

A method and an apparatus of automatically adjusting a flicker of the LCD is described below with reference to FIGS. 3, 4, 5A, 5B, 6, 7A, 7B, 7C, 7D, 7E, 8, 9A, and 9B

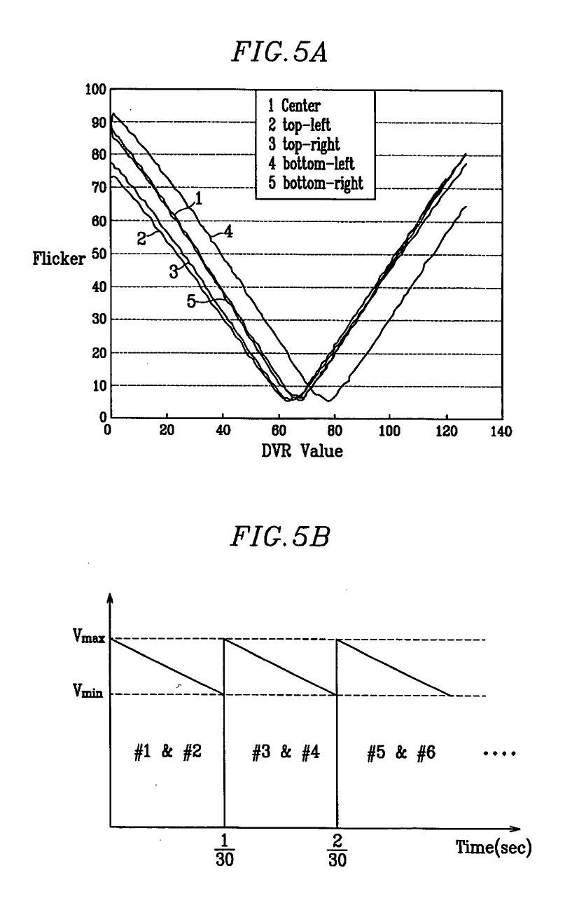

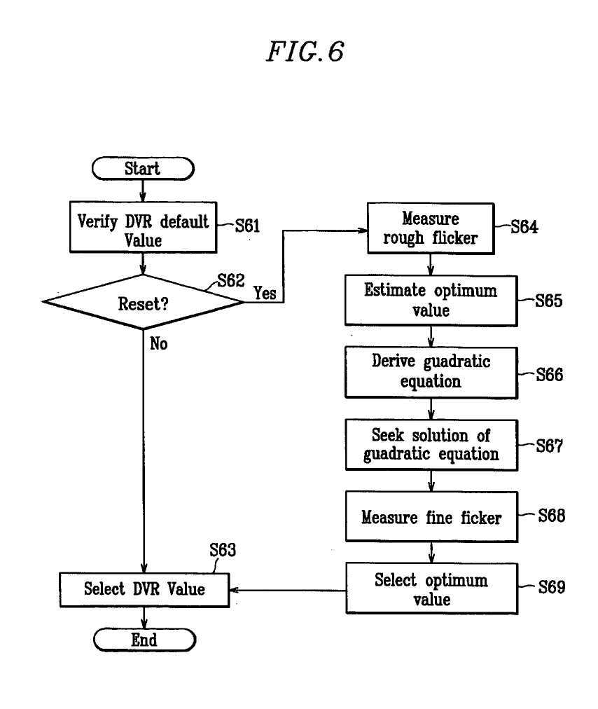

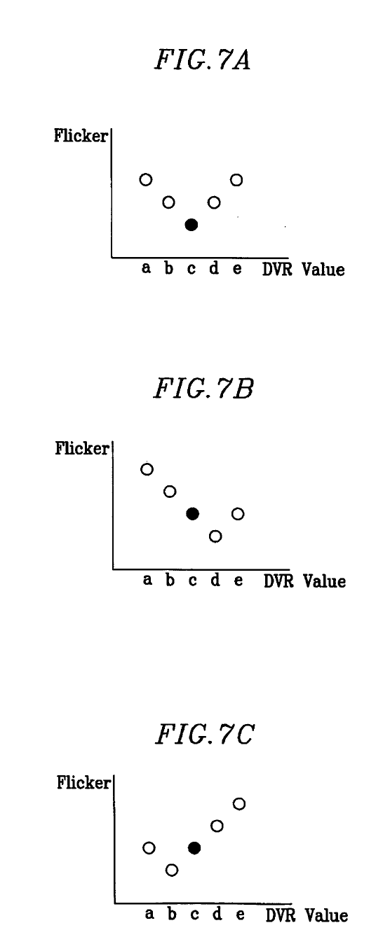

FIG. 3 shows a flicker adjusting system of an LCD according to an embodiment of the invention. FIG. 4 is a block diagram of a flicker adjusting system of an LCD according to an embodiment of the invention. FIG. 5A is a graph showing a flicker amount depending on DVR values in an LCD according to an embodiment of the invention. FIG. 5B shows a principle to measure a flicker amount. FIG. 6 is a flow chart showing a flicker adjusting method of an LCD according to an embodiment of the present invention.

Referring to FIG. 3 and FIG. 4, a flicker adjusting system includes an LCD 11, a photographing device 21, and a computer 31.

The LCD 11 is connected, e.g., coupled, with the computer 31 and includes a plurality of points 1-5 representing positions. For example, the plurality of points include, a center point 1, a top-left point 2, a top-right point 3, a bottom-left point 4, and a bottom-right point 5.

The photographing device 21 is connected, e.g., coupled, with the computer 31 and photographs the center 1, and/or all of the points, and/or the entire screen. For example, for photographing the center point 1, the photographing device 21 may be one luminance meter, for photographing five points 1-5, the photographing device 21 may be five luminance meters, and is for photographing the entire screen, the photographing device 21 may be a charge coupled device (CCD).

The photographing device 21 measures luminance of the screen so that the measured luminance may be converted into an electric signal. For example, the electric signal may be a voltage for output to the computer 31.

The computer 31 may include a data acquisition unit 31a acquiring data from the photographing device 21, a data processing unit 31b processing the acquired data, and a data conversion unit 31c converting the processed data to output the digital variable register (DVR) 710 of the LCD.

The data acquisition unit 31a acquires the data from the photographing device 21 to calculate data for a flicker amount. The data processing unit 31b determines an optimum value for the calculated flicker data to input to the DVR 710. The data conversion unit 31c converts the optimum value into data that may be transmitted to the DVR 710. The computer 31 and the DVR 710 are connected, e.g. coupled, by I²C interface lines to transmit the data that is divided into clock signals and data. The DVR 710 may have a pin for a write-unable signal, e.g., a signal that does not permit the occurrence of an event in addition to pins enabling for the clock signals and the data.

FIG. 5A is a graph for measuring flickers depending on DVR values for respective points 1-5 of the screen of the LCD 11.

Hereinbelow, values input to the DVR 710 are referred to as ‘DVR values.’

The DVR value is converted from a binary number into a decimal number. The graph shows measurements of the flicker for 128 DVR values using a 7-bit memory (not shown) included in the DVR 710.

Referring to FIG. 5A, the flicker reduces to a particular point and increases depending on an increase of the DVR values. The flicker has a minimum value at the particular point.

The flicker is a phenomenon expressed due to a difference of luminance when the data voltages of a positive polarity and the data voltages of a negative polarity are applied, respectively. The flicker may be quantified using Equation 1.

$$\begin{matrix}EQUATION 1 & \\ \begin{matrix}A flicker amount = alternating current component \text{/} direct current component \\ = ( V max - V min ) / \{ ( V max + V min ) / 2 \} * 100 [ \% ]\end{matrix} & ( 1 )\end{matrix}$$

Vmax is a maximum value of values converted into voltages measuring the luminance, and Vmin is a minimum value thereof.

As shown by Equation 1, the flicker amount may be defined as representing a ratio of the alternating current (AC) component to the direct current (DC) component as a percentage. The AC component is the difference of the maximum value and the minimum value and the DC component is a mean value for one period.

Referring to FIG. 5B, when inversion driving is performed for each frame in an LCD displaying image at 60 frames per second, one frame corresponds to 1/60 of a second, two frames correspond to 1/30 second, etc. Thus, a period of the flicker is 1/30 of a second, and a brightness of odd frames differs from a brightness of even frames and is expressed as the graph shown in FIG. 5B. For example, for a first frame #1 and a second frame #2, the first frame #1 may be brighter than the second frame #2.

Embodiments of the present invention are described below. The embodiments of the present invention are classified according to types of photographing devices and the number thereof. For example, the embodiments discussed include a single probe mode of photographing the center point 1 of the screen of the LCD 11 using one luminance meter, a multi-probe mode of photographing five points thereof using five luminance meters, and a camera mode of photographing the entire screen using a CCD camera.

I. Single Probe Mode

FIG. 6 is a flow chart showing a flicker adjusting method of an LCD according to an embodiment of the invention.

In operation S61, a default value stored in the DVR 710 is read to verify an optimum value to minimize the flicker. The verification may be performed by inputting several values of left and right including the default value, for example, 3 to 5 values.

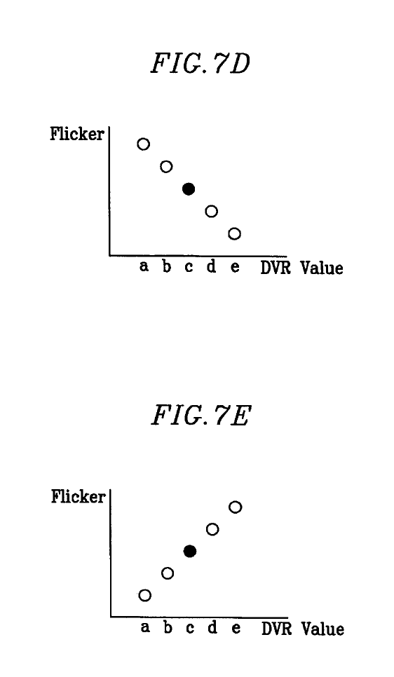

FIGS. 7A, 7B, 7C, 7D and 7E show several samples for the verification procedure and show the flicker values. In this case, points represented as black dots are the default values c. In FIG. 7A, the default value may be used as it is shown on the graph, but for the default values shown in the remaining drawings, optimum values must be set.

Whether the DVR value is set again, e.g., reset, is determined by the verification in operation S62.

In operation S64, a first, e.g., rough, flicker measurement is performed. The rough flicker measurement indicates that, for a 7-bit DVR 710, 128 values of from 0 to 127 are input thereto and the flicker is measured while approximately 8 to 12 values of 128 values are input thereto by a predetermined unit. For example, when 8 values are inputted the DVR 710, values 0, 15, 31, . . . , 127 are inputted. A rough graph is acquired from the inputted values as shown in FIG. 5A.

An optimum value is then estimated in operation S65.

Of the 8 inputted DVR values, the estimated optimum value is a value that causes the flicker to be minimized.

A quadratic equation is then derived in operation S66.

As described in above FIG. 5A, a curve around the minimum value is a convex parabola and may be expressed as a numerical formula.
y=ax²+bx+c (2)

where x is the DVR value and y is the flicker amount. There are three numerical coefficients and thus the estimated optimum value and two values of the front and the rear adjacent thereto are input to derive the quadratic equation shown in Equation 2. For example, when the flicker amount includes the minimum value for the DVR value of 63, the flicker amounts according to 47 and 79 are input into the quadratic equation.

The quadratic equation derived in operation S66 is solved in operation S67.

The quadratic equation is differentiated to determine a gradient. The solution is a DVR value that causes the gradient to be 0.

A second, e.g., fine, flicker measurement is performed in operation S68.

The fine flicker measurement verifies the DVR value sought in the operation S67. The verification may be performed by inputting five values, for example the DVR value and two values of the front and two values of the rear of the DVR value as described in FIGS. 7A, 7B, 7C, 7D, and 7E. For example, in FIG. 7A, when the value c is 65, two values of the front thereof are 63 and 64 and two values of the rear thereof are 66 and 67.

The verification in operation S61 is different than the verification in operation S68. In operation S68, the verification is performed after deriving the equation and seeking the solution thereof, thus a probability to represent the graphs shown in FIGS. 7A, 7B, and 7C is high. On the contrary, in operation S61, a probability to represent any one of the graphs shown in FIGS. 7A, 7B, 7C, 7D, and 7E is high when verifying the default value.

Meanwhile, during the verification process, when the graph shown in FIG. 7A is represented, the DVR value sought in operation S67 is an optimum value, the value d is an optimum value for the graph shown in FIG. 7B, and the value b is an optimum value for the graph shown in FIG. 7C. Additionally, for those shown in FIG. 7D and FIG. 7E, five values with respect to the values e and a are again input, and the procedure described above is repeated.

Accordingly, a DVR value to minimize the flicker is determined in operation S83, and the determinant value is input to the DVR 710 of the LCD 11.

II. Multi-Probe Mode

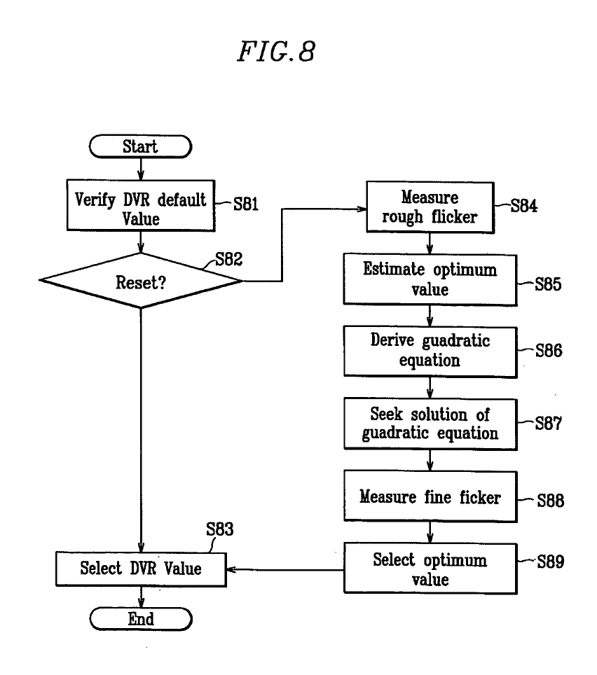

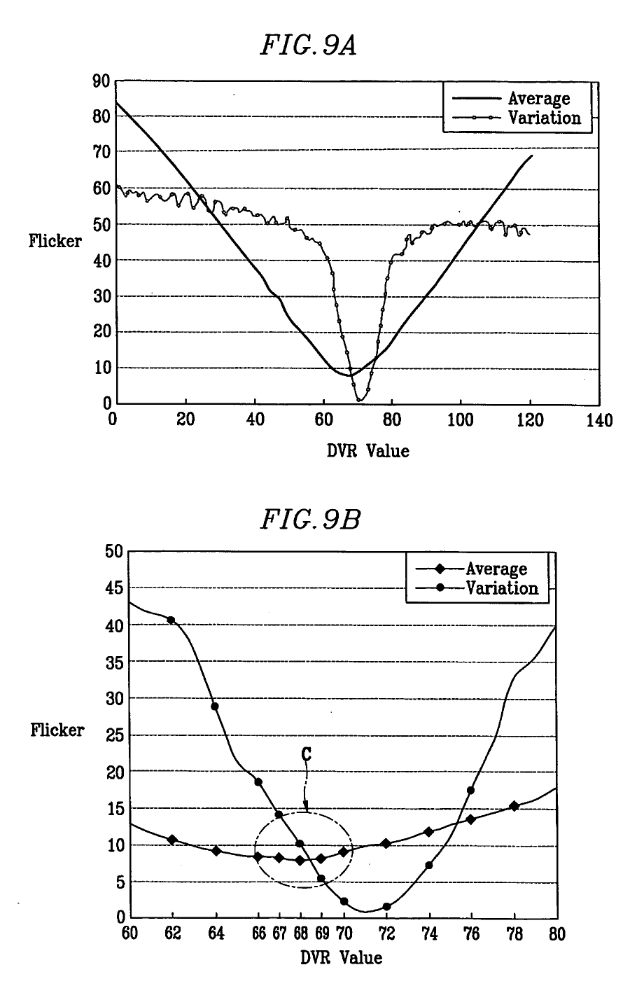

FIG. 8 is a flow chart showing a method for adjusting a flicker of an LCD according to another embodiment of the invention. FIG. 9A and FIG. 9B show a reference for selecting an optimum value in a flicker adjusting method of an LCD according to another embodiment of the invention.

The multi-probe mode is a mode to photograph the respective points 1-5 using a plurality of luminance meters, for example, five luminance meters as described above, and is substantially identical to the signal probe mode except that an average and a variation for the five points 1-5 is determined.

A default value of the DVR 710 is verified in operation S81. The verification determines whether to reset a default value in operation S82.

When the default value is reset, in operation S84 8 DVR values are input to measure a rough flicker in operation S84. An optimum value is estimated in operation S85. The estimation for the optimum value may be performed by averaging five points and estimating a DVR value to minimize the average value as an optimum value.

In operation S86, the estimated optimum value and two values adjacent thereto are then input to derive a quadratic equation as shown in Equation 2. The quadratic equation is then solved in operation S87.

The value sought in operation S87 and several other values are input to perform a 20 fine flicker measurement in operation S88. Graphs shown in FIG. 9A and FIG. 9B are sought. An optimum value is selected using an average and a variation in operation S89. For example 6, the average value is a value used to divide the flicker amounts in the respective points 1-5 by 5, and the variation is a difference between the maximum and the minimum values of the flicker amounts in the respective points 1-5.

FIG. 9A is a graph used for measuring the flicker amount for the DVR values. FIG. 9B is a graph used for enlarging a periphery of the minimum value.

In the portion C shown in FIG. 9B, the average values are nearly the same, and the corresponding DVR values are approximately 66 to 70 of which an optimum value is selected. A value located at a periphery of the average value that minimizes the variation, is selected as an optimum value. For example, for the variations corresponding to 68 and 69 of the DVR values, the variation is about 11 for 68 and the variation is about 5 for 69; therefore, 69 is selected as the optimum value because there is less variation.

In operation S83, the optimum value is selected as a DVR value and the value is then input to the DVR 710 of the LCD 11.

III. Camera Mode

Another embodiment of the invention is a method for optimizing the flicker by photographing an entire screen using a CCD camera as the photographing device 21.

Embodiments of the invention that use the luminance meter measure luminance variations at specific points for conversion into voltages. Embodiments of the invention that use the CCD camera measure luminance variations for the entire screen for conversion into voltages.

The measurement of the luminance variation for the entire screen is performed by dividing the entire screen area into a plurality of areas to measure a flicker amount for each area, which is substantially similar to the multi-probe mode. For example, a specific point is enlarged and a flicker amount is measured for the enlarged portion. Accordingly, there are many divided areas, which increases an amount of data to be processed. However, the optimization process is the same as that the optimization process shown in FIG. 8 and thus is described with reference to FIG. 8 for purposes of convenience.

A default value of the DVR 710 is verified in operation S81. When resetting the default value, a rough flicker measurement is performed in operation S84.

The verification of the default value and the measurement of the flicker are performed by recording a luminance variation of the screen for the first frame and the second frame. The luminance variation may be determined using a camera that is capable of photographing approximately 60 frames per second. The flicker is measured by a unit of two frames, which is similar to the embodiments using the luminance meters.

In operation S85, 8 DVR values are input to measure a rough flicker and then an optimum value is estimated. A quadratic equation is derived in operation S86 and solved in operation S87. A fine flicker measurement is performed in operation S88.

In operation S89, an optimum value is then selected using an average and a variation. For example, the average value is a value to divide the flicker amounts in the respective areas by the number of the areas and the variation is a difference of the maximum and the minimum values of the flicker amounts in the respective areas.

In operation S83, the optimum value is selected as the DVR value and input to the DVR 710.

As described above, according to the present embodiments, an optimum value for minimizing the flicker may be determined by changing the DVR value to the maximum value of 24 times including the verification of the default fault, for example, 3 to 5 times at the verification of the default value, 8 times at the rough flicker measurement, and 5 to 11 times at the fine flicker measurement. Since one measurement requires 1/30 of a second, which is a period of the flicker, that is, 33 ms, even the maximum number of measurements of 24 requires only 792 ms, which is less than 1 second. Of course, when verification of the default value does not need to be reset, time is reduced significantly.

Additionally, the data is written to and/or read from the DVR using an I²C interface so that management of information is convenient, and the flicker and flicker history of the LCD is easily analyzed and managed.

Moreover, the present invention is not performed manually, which prevents variations caused by operator differences.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for automatically adjusting a flicker of a liquid crystal display comprising a digital variable resistor (DVR) that generates a common voltage according to an input signal, the method comprising:
providing a photographing device to measure luminance of the liquid crystal display;
verifying a default value stored in the DVR;
performing a first flicker measurement;
generating a predetermined equation using data obtained from the first flicker measurement and solving the generated quadratic equation;
performing a second flicker measurement;
selecting an optimum value from data obtained from the second flicker measurement; and
inputting the optimum value to the DVR.

2. The method of claim 1, wherein the predetermined equation is a quadratic equation.

3. The method of claim 2, wherein the photographing device photographs a substantially center point of the liquid crystal display.

4. The method of claim 3, wherein verifying the default value stored in the DVR comprises inputting three to five values including the default value to the DVR.

5. The method of claim 4, wherein performing the first flicker measurement comprises inputting eight to twelve values to the DVR by a predetermined unit to measure the flicker.

6. The method of claim 5, wherein generating the quadratic equation comprises:
estimating the optimum value to minimize the flicker; and
generating the quadratic equation using the estimated optimum value and a smaller value and a larger value than the estimated optimum value.

7. The method of claim 6, wherein performing the second flicker measurement comprises inputting at least five values including the solution of the quadratic equation and a smaller value and a larger value than the solution to the DVR to measure a flicker.

8. The method of claim 7, wherein selecting the optimum value comprises:
measuring flickers for at least five input values to generate a graph; and
selecting a value positioned at a vertex of a curve as the optimum value.

9. The method of claim 8, wherein selecting the optimum value further comprises:
when the graph is substantially a straight line, repeatedly inputting at least five values with respect to a DVR value located at the lowest portion of the straight line to the DVR to obtain a curved shape.

10. The method of claim 9, wherein an amount of the flicker is defined as (Vmax−Vmin)/{(Vmax+Vmin)/2}*100 or a percentage ratio of an AC component to a DC component,
wherein Vmax is a maximum value of values converted into voltages measuring a luminance and Vmin is a minimum value thereof.

11. The method of claim 2, wherein the photographing device photographs first to fifth points of the liquid crystal display.

12. The method of claim 11, wherein verifying the default value stored in the DVR comprises inputting three to five values including the default value to the DVR.

13. The method of claim 12, wherein performing the first flicker measurement comprises inputting eight to twelve values to the DVR by a predetermined unit to measure a flicker.

14. The method of claim 13, wherein generating the quadratic equation comprises:
determining average values for flickers represented by the first to the fifth points for the input values;
estimating a value corresponding to a minimum value of the average values as the optimum value; and
generating the quadratic equation using the estimated optimum value and a smaller value and a larger value than the estimated optimum value.

15. The method of claim 14, wherein performing the second flicker measurement comprises inputting at least five values including a solution of the quadratic equation and a smaller value and a larger value than the solution to the DVR to measure a flicker.

16. The method of claim 15, wherein selecting the optimum value comprises:
measuring flickers for at least five input values to determine average values and variations for flickers represented by the first point to the fifth point; and
selecting a value having the smallest variation as the optimum value.

17. The method of claim 16, wherein an amount of the flicker is determined by (Vmax−Vmin)/{(Vmax+Vmin)/2}*100, or a percentage ratio of an AC component to a DC component,
wherein Vmax is a maximum value of values converted into voltages measuring a luminance, and Vmin is a minimum value thereof.

18. The method of claim 2, wherein the photographing device photographs an entire screen of the liquid crystal display.

19. The method of claim 18, wherein verifying the default value stored in the DVR comprises inputting three to five values including the default value to the DVR.

20. The method of claim 18, wherein performing the first flicker measurement comprises inputting eight to twelve values to the DVR by a predetermined unit to measure a flicker.

21. The method of claim 20, wherein generating the quadratic equation comprises:
dividing the entire screen into a plurality of areas to determine average values for flickers represented by the respective areas for the input values;
estimating a value corresponding to a minimum value of the average values as the optimum value; and
generating the quadratic equation using the estimated optimum value and a smaller value and a larger value than the estimated optimum value.

22. The method of claim 21, wherein performing the second flicker measurement comprises inputting at least five values including a solution of the quadratic equation and a smaller value and a larger value than the solution to the DVR to measure a flicker.

23. The method of claim 22, wherein selecting the optimum value comprises:
measuring flickers for at least five input values to determine average values and variations for flickers represented by the respective areas; and
selecting a value having the smallest variation as the optimum value.

24. The method of claim 23, wherein an amount of the flicker is determined by as (Vmax−Vmin)/{(Vmax+Vmin)/2}*100, or a percentage ratio of an AC component to a DC component,
wherein Vmax is a maximum value of values converted into voltages measuring a luminance, and Vmin is a minimum value thereof.

25. A system to automatically adjust a flicker, comprising:
a liquid crystal display (LCD);
a photographing device photographing the LCD; and
an electronic device coupled with the liquid crystal display and the photographing device,
wherein the liquid crystal device comprises a DVR that generates common voltages having different values according to an input signal received from the electronic device, and the electronic device determines a value for minimizing a flicker of the liquid crystal display to input to the DVR.

26. The system of claim 25, wherein the electronic device comprises:
a detection unit acquiring luminance data from the photographing device to detect an amount of the flicker;
an operation unit determining the value for minimizing the flicker according to the detected amount of the flicker; and
a conversion unit converting the value for minimizing the flicker into data to input to the DVR.

27. The system of claim 26, wherein the electronic device is coupled with the DVR by an I²C interface.

28. The system of claim 27, wherein the amount of the flicker is determined by (Vmax−Vmin)/{(Vmax+Vmin)/2}*100 into, or a percentage ratio of an AC component to a DC component,
wherein Vmax is a maximum value of values converted into voltages measuring a luminance, and Vmin is a minimum value thereof.

29. The system of claim 28, wherein the photographing device comprises at least one luminance meter.

30. The system of claim 29, wherein the photographing device photographs at least one point of an entire screen of the liquid crystal display.

31. The system of claim 28, wherein the photographing device is a charge coupled device (CCD) camera.

32. The system of claim 31, wherein the CCD camera photographs an entire screen of the liquid crystal display.

33. A liquid crystal display comprising a DVR that generates a first common voltage according to an input signal received from an external device, wherein the DVR is coupled with the external device an I²C interface.

34. The liquid crystal display of claim 33, wherein the DVR comprises a pin applied with a clock signal and a pin applied with data.

35. The liquid crystal display of claim 34, wherein the DVR further comprises a pin applied with a write-unable signal.

36. The liquid crystal display of claim 33, further comprising a common voltage generator generating at least one second common voltage according to the first common voltage.

37. A liquid crystal device comprises a DVR that generates common voltages having different values according to an input signal received from an electronic device, and the electronic device determines a value for minimizing a flicker of the liquid crystal display to input to the DVR.

38. The liquid crystal display of claim 37, wherein the electronic device is coupled with the DVR by an I²C interface.

39. The liquid crystal display of claim 37, wherein the DVR comprises a pin applied with a clock signal and a pin applied with data.

40. The liquid crystal display of claim 39, wherein the DVR further comprises a pin applied with a write-unable signal.
